(19) United States
(12) Patent Application Publication
(10) Pub. No.: US 2008/0186406 A1
(43) Pub. Date: Aug. 7, 2008

(54) APPARATUS FOR DETECTING FILM MODE AND METHOD THEREOF

(76) Inventor: Po-Wei Chao, Taipei County (TW)

Correspondence Address: NORTH AMERICA INTELLECTUAL PROPERTY CORPORATION, P.O. BOX 506, MERRIFIELD, VA, 22116, US

(21) Appl. No.: 11/672,051

(22) Filed: Feb. 7, 2007

(51) Int. Cl. H04N 7/01

(52) U.S. Cl. 348/700; 348/E07.015; 382/107

(57) ABSTRACT

The invention discloses an apparatus for dynamically detecting film mode and a method thereof. The method for detecting a film mode includes receiving an video signal; detecting an image characteristic based on at least one field of the received signal; generating a control signal according to the image characteristic of the received signal; fetching the control signal to a film mode detection module; selecting a target motion detection mechanism out of a plurality of candidate motion detection mechanisms based on the control signal; and detecting the film mode of the field by utilizing the target motion detection mechanism. The apparatus detects the interference of noise, slight motion and partial motion in the field, and correctly determines the film mode of varied images.

### BACKGROUND

The invention relates to an apparatus for detecting film mode and a method thereof, and more particularly, to an apparatus for dynamically detecting film mode and a method thereof.

The conventional method used by a film mode detector for detecting a film mode comprises determining whether there is motion in the adjacent images, getting a motion sequence according to the determination results, and then identifying the film mode (2:2 pull down or 3:2 pull down) based on the motion sequence.

As shown in FIG. 1, a conventional field motion detector 10 comprises a motion detecting unit 12, a motion summing unit 14 and a field motion determining unit 16. When an input field is fetched into the field motion detector 10, the motion detecting unit 12 compares pixels of the input field with the corresponding pixels of an adjacent field to calculate the motion values of the input field. After the motion values of the input field are calculated, the motion summing unit 14 sums up the motion values and transmits the sum to the field motion determining unit 16 to compare the sum of the motion values with a predetermined fix threshold value.

According to the conventional method, the motion detecting unit 12 is used to analyze the motion levels sequentially by comparing pixels of the input field, and the field motion determining unit 16 compares the motion level with a fixed threshold to determine the film mode motion. Since the field may suffer from noise interference in the transmission, each pixel value of the field will incur an additional noise value, and the motion value of the field may be altered. The conventional method, as illustrated in FIG. 1, could lead to an incorrect decision while a predetermined and fixed threshold value is utilized to detect the field motion. For example, a field having no image motion will be erroneously identified by the field motion determining unit 16 as a field having image motion when the motion value of the field exceeds the threshold value due to noise interference. Moreover, since the type of the input field is unknown when the threshold value is determined, the threshold value may be larger than the motion value of a field having slight motion or partial motion. As a result, the field motion determining unit 16 may erroneously determine the field having slight motion or partial motion as a field having no image motion

### SUMMARY

One objective of the claimed invention is to provide an apparatus and a method thereof that dynamically adjust a detection scheme utilized for detecting the film mode according to the image characteristic to thereby allow simple and efficient film mode detection of varied images.

According to an exemplary embodiment of the claimed invention, a method for detecting a film mode comprises receiving an video signal; detecting an image characteristic based on at least one field of the received signal; generating a control signal according to the image characteristic of the received signal; fetching the control signal to a film mode detection module; selecting a target motion detection mechanism out of a plurality of candidate motion detection mechanisms based on the control signal; and detecting the film mode by utilizing the target motion detection mechanism.

According to another exemplary embodiment of the claimed invention, an apparatus for detecting a film mode comprises an image characteristic detection module, for detecting an image characteristic based on at least one field of a received video signal and generating a control signal to select a target motion detection mechanism out of a plurality of candidate motion detection mechanisms according to the image characteristic; and a film mode detection module, for receiving the control signal and detecting the film mode by utilizing the target motion detection mechanism.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram of a conventional field motion detector.

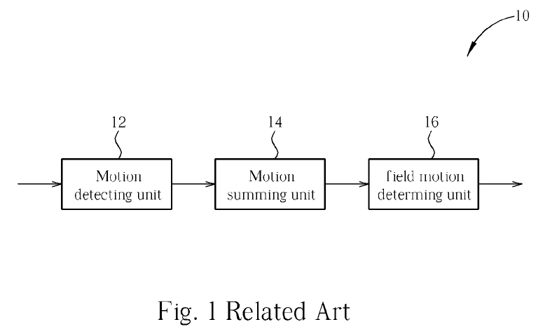

FIG. 2 is a diagram of an apparatus for dynamically detecting a film mode according to an exemplary embodiment of the invention.

FIG. 3 is a detailed diagram of the apparatus shown in FIG. 2.

FIG. 4 is a diagram of an image characteristic detection module according to an exemplary embodiment of the invention.

FIG. 5 is a diagram of an image characteristic detection module according to another exemplary embodiment of the invention.

FIG. 6 is a diagram of an image characteristic detection module according to another exemplary embodiment of the invention.

FIG. 7 is a diagram of an image characteristic detection module according to another exemplary embodiment of the invention.

FIG. 8 is a diagram of a field being divided into a plurality of regions.

FIG. 9 is a diagram of an image characteristic detection module according to another exemplary embodiment of the invention.

### DETAILED DESCRIPTION

Certain terms are used throughout the description and following claims to refer to particular components. As one skilled in the art will appreciate, manufacturers may refer to a component by different names. This document does not intend to distinguish between components that differ in name but not function. In the following description and in the claims, the terms “include” and “comprise” are used in an open-ended fashion, and thus should be interpreted to mean “include, but not limited to . . . ”. Also, the term “couple” is intended to mean either an indirect or direct electrical connection. Accordingly, if one device is coupled to another device, that connection may be through a direct electrical connection, or through an indirect electrical connection via other devices and connections.

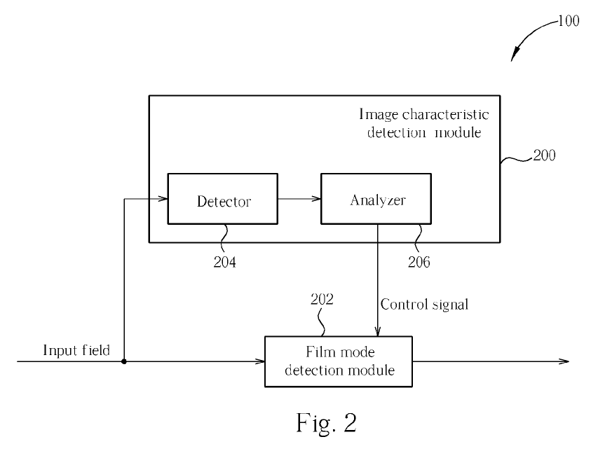

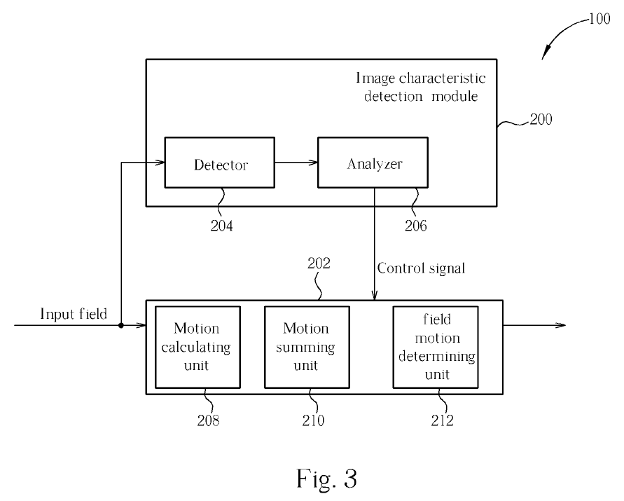

The invention aims at dynamically adjusting a detection scheme utilized for detecting the film mode according to the estimated image characteristic of at least one field. In an exemplary embodiment of the invention shown in FIG. 2, an apparatus 100 for detecting a film mode comprises an image characteristic detection module 200 and a film mode detection module 202, wherein the image characteristic detection module 200 comprises a detector 204 and an analyzer 206 coupled to the detector 204 and the film mode detection module 202. FIG. 3 shows an exemplary embodiment of the film mode detection module 202. As shown in FIG. 3, the film mode detection module 202 comprises a motion calculating unit 208, a motion summing unit 210 and a field motion determining unit 212. The functions of those units in the film mode detection module 202 are substantially the same with those of the conventional film mode detector 10. That is, the motion detecting unit 208 is for comparing pixels of an input field and the corresponding pixels of an adjacent field to calculate the motion values of the field. The motion summing unit 210 is for summing up the motion values, and the sum of the motion values is transmitted to the field motion determining unit 212 to compare the sum of the motion values with a threshold value, which is decided by the control information. Unlike the conventional method, the threshold value is fixed and predetermined set to be in the field motion determining unit 212. Thus, the exemplary embodiment of the film mode detection provide the method to determine more accurate and adaptive threshold value/level from analyzing image characteristic detection module 200. Please note that the motion calculating unit 208 could be built inside the image characteristic detection module 200 as well, and the image characteristic detection module 200 and the film mode detection module 202 therefore utilize a shared motion calculating unit.

When the image characteristic detection module 200 receives a field, the detector 204 detects some specific characteristics of the field, and then the analyzer 206 determines an image characteristic according to the specific characteristics detected by the detector 204 and generates a control signal to the film mode detection module 202 to adjust a detection scheme according to the image characteristic. For example, the image characteristic detection module 200 may select a motion detection mechanism out of a plurality of candidate motion detection mechanisms, such as a field motion detection and a frame motion detection used in the film mode detection module 202, or adjust at least one motion threshold referred to by the active motion detection mechanism according to the image characteristic. Then the film mode detection module 202 detects the film mode of the field by utilizing the motion detection mechanism according to the adjusted motion threshold.

This image characteristic estimation procedure is repeated for each following field; in other words, the image characteristic detection module 200 detects the image characteristics of a plurality of fields respectively, and dynamically adjusts the detection scheme according to the image characteristics. Since the detection scheme utilized for detecting the film mode is not fixed but adaptive to the fields, the unexpected detection errors, caused by noise interference, slight motion, partial motion, etc. . . . , is able to be well avoided.

The following explains the operation of the image characteristic detection module 200 in detail. There are four types of the image characteristic detection module 200 are illustrated as exemplary embodiments, wherein the first exemplary embodiment of the image characteristic detection module 200 could be utilized for detecting noise/motion level, the second exemplary embodiment of the image characteristic detection module 200 could be utilized for detecting noise level, the third exemplary embodiment of the image characteristic detection module 200 could be utilized for detecting motion area, and the fourth exemplary embodiment is a combination of the first and the third exemplary embodiment. Please note that the disclosed function of the image characteristic detection module in each embodiment detailed in the following paragraphs is for illustrative purposes only and is not meant to be a limitation of the present invention.

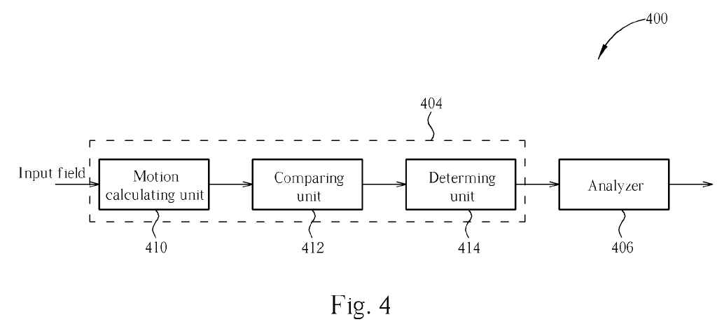

FIG. 4 is a diagram of the first exemplary embodiment of the image characteristic detection module 400. As shown in FIG. 4, the detector 404 comprises a motion calculating unit 410, a comparing unit 412 and a determining unit 414. In order to detect the motion/noise level of the input field, the motion calculating unit 410 first calculates a plurality of motion values of a plurality of pixels in the field. Then the comparing unit 412, implemented by a quantizer in this embodiment, quantizes the motion value by comparing the motion value of the field with at least one threshold value to generate a plurality of comparison results, and the determining unit 414, implemented by an adder in this embodiment, determines the motion/noise level by summing up the comparison results. The analyzer 406 then determines whether the field has low motion/noise or high motion/noise by comparing the motion/noise level with a threshold. If the field is detected to have high motion/noise, the motion threshold utilized by the film mode detection module 202 will be adjusted to become higher since the motion value of the field might be interfered by noise seriously. Alternatively, the motion calculating unit 410 could be built inside the film mode detection module 202 shown in FIG. 2; in other words, the image characteristic detection module and the film mode detection module could utilize a shared motion calculating unit. In this case, the input of the image characteristic detection module is the motion values provided from the motion calculating unit embedded in the film mode detection module 202. These alternative designs all fall within the scope of the present invention.

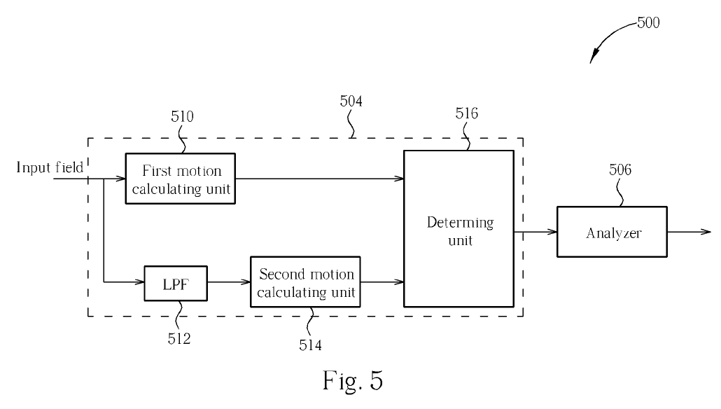

Differing from the first exemplary embodiment shown in FIG. 4, which treats the motion and the noise together, the second exemplary embodiment is utilized to detect the noise level. Please refer to FIG. 5, which illustrates the second exemplary embodiment of the image characteristic detection module 500, wherein the detector 504 of the image characteristic detection module 500 comprises a first motion calculating unit 510, a low pass filter (LPF) 512, a second motion calculating unit 514 and a determining unit 516. The LPF 512 performs a filtering operation upon the field to filter out the noise in the field and generate a filtered field. The output of the first motion calculating unit 510 is first motion values of a plurality of pixels in the field, and the output of the second motion calculating unit 514 is second motion values of the corresponding pixels in the filtered field. By comparing the first motion values and the second motion values, the determining unit 516 determines whether the field is a noise image. The determining rule is that if the motion values of the field and the filtered field are not the same, the field is regarded as being interfered by noise. In this case the motion threshold utilized by the film mode detection module 202 will be adjusted to become higher to compensate for the effect on motion values caused by the noise interference.

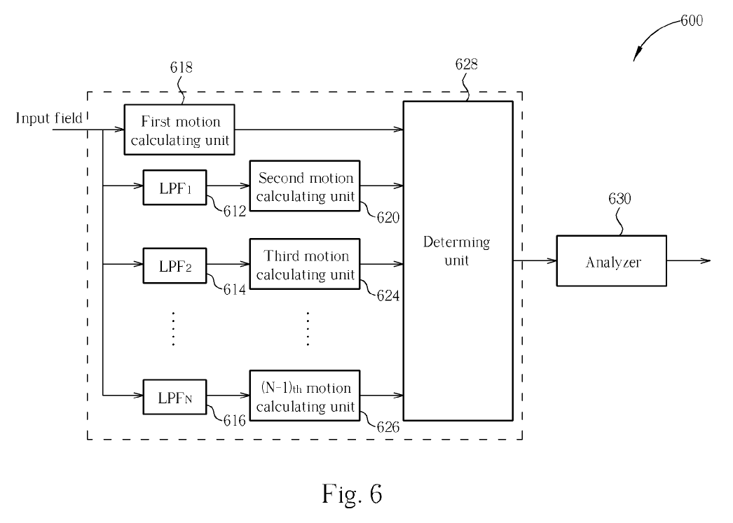

The image characteristic detection module shown in FIG. 6 is another embodiment of the second exemplary embodiment shown in FIG. 5. A plurality of LPFs having different transfer functions 612, 614, 616 are utilized for filtering out noise of different levels, hence the outputs of the motion calculating unit 618, 620, 624, 626 are the motion values of the pixels in the field having different noise levels. By comparing the outputs of the motion calculating unit 618, 620, 624, 626, the determining unit 628 determines the noise level, and the analyzer 630 determines the image characteristic of the field (the noise level is high or low, for example) and generates a control signal to adjust the detection scheme utilized for the film mode detection module 202 according to the image characteristic.

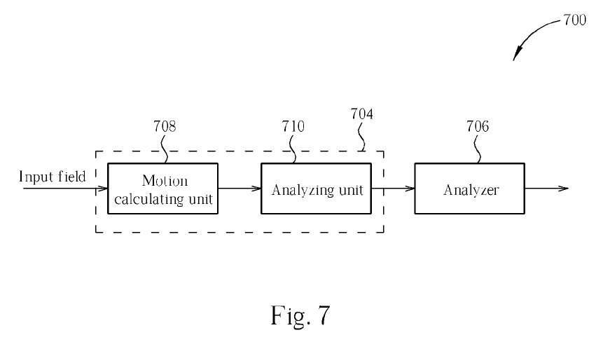

Please refer to FIG. 7, which is a diagram of the third exemplary embodiment of the image characteristic detection module. The image characteristic detection module 700 comprises a detector 704 for detecting a motion area of the field and an analyzer 706, wherein the detector 704 comprises a motion calculating unit 708 and an analyzing unit 710. The operation of the motion calculating unit 708 is the same as the motion calculating unit 410 in FIG. 4, and clearly, it could be built in the film mode detection module, too. As mentioned before, when the image characteristic detection module and the film mode detection module utilize a shared motion calculating unit, the input of the image characteristic detection module is the motion values provided from the motion calculating unit of the film mode detection module.

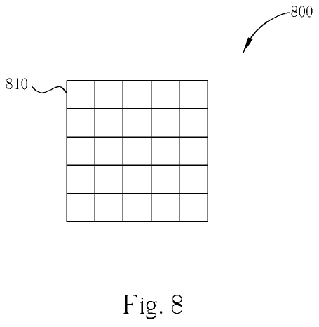

After receiving the motion values calculated by the motion calculating unit 708, the analyzing unit 710 analyzes the motion values to determine the motion area of the field. For example, referring to FIG. 8, an input field 800 is divided into several regions 810, and the analyzing unit 710 determines the motion area of the field 800 according to the number of the regions 810 that are identified to have motions. Since the noise has an important characteristic—it is uniformly distributed over the field, the field having a small motion area is not possible to be a field affected by noise interference. Moreover, the field having a small motion area usually has smaller motion values; therefore the analyzer 706 in FIG. 7 will adjust the motion threshold utilized for detecting the film mode to become lower, thereby avoiding the wrong detection due to ignoring slight motion and partial motion of the field.

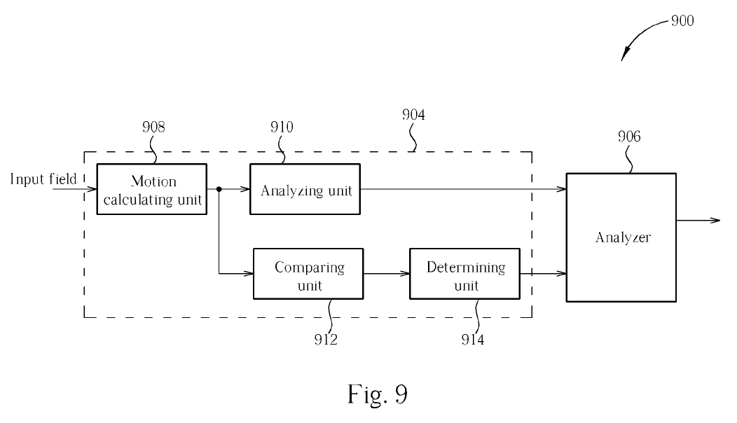

On the other hand, if the motion area of the field is large, the field might be a seriously affected by noise or be a motion image having large motions. The motion/noise level of the field can be analyzed in order to adjust the detection scheme of the film mode detection module 202 accordingly. FIG. 9 illustrates an image characteristic detection module 900 of the fourth exemplary embodiment of the invention, which is a combination of the first exemplary embodiment in FIG. 4 and the third exemplary embodiment in FIG. 7. In FIG. 9, the motion values calculated by the motion calculating unit 908, which has the same function as the motion calculating unit 410 in FIG. 4, is input into the analyzing unit 910 having the same function as the analyzing unit 710 in FIG. 7 and the comparing unit 912 having the same function as the comparing unit 412 in FIG. 4, respectively. The analyzer 906 here determines the image characteristic of the input field according to the motion area detected by the analyzing unit 910 and the motion/noise level detected by the comparing unit 912 and the determining unit 914. Therefore the image characteristic detection module 900 detects the image characteristic and adjusts the detection scheme according to both the motion area and the motion level, so that the detection results of the film mode detection module 202 are more accurate and the detection procedure is more efficient.

In addition, although the image characteristic detection module is utilized for film mode detection in the invention, it could be utilized in other image processing fields, such as de-interlacing, Y/C separation, false color suppression and noise reduction as well. After reading the above disclosure, a skilled person can readily appreciate the implementation of the disclosed image characteristic detection module in other image processing fields. Further description is omitted here for brevity.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method for detecting a film mode, comprising:
receiving an video signal;
detecting an image characteristic based on at least one field of the received signal;
generating a control signal according to the image characteristic of the received signal;
fetching the control signal to a film mode detection module;
selecting a target motion detection mechanism out of a plurality of candidate motion detection mechanisms based on the control signal; and
detecting the film mode by utilizing the target motion detection mechanism.

2. The method of claim 1, wherein detecting the image characteristic comprises:
detecting a noise level of the field; and
determining the image characteristic according to the noise level.

3. The method of claim 2, wherein detecting the noise level of the field comprises:
calculating a plurality of motion values of a plurality of pixels in the field;
comparing the motion values with at least one threshold value to generate a plurality of comparison results; and
determining the noise level according to the comparison results.

4. The method of claim 3, wherein comparing the motion values with at least one threshold value comprises:
utilizing at least one threshold value to quantize the motion values to generate the comparison results.

5. The method of claim 4, wherein determining the noise level comprises:
summing up the comparison results to determine the noise level.

6. The method of claim 2, wherein detecting the noise level of the field comprises:
calculating a plurality of first motion values of a plurality of pixels in the field;
performing a filtering operation upon the field to generate a filtered field;
calculating a plurality of second motion values of the pixels in the filtered field; and
determining the noise level according to the first motion values and the second motion values.

7. The method of claim 1, wherein detecting the image characteristic comprises:
detecting a motion level of the field to determine the image characteristic.

8. The method of claim 1, wherein detecting the image characteristic comprises:
detecting a motion area of the field to determine the image characteristic.

9. The method of claim 1, wherein at least a motion threshold referred to by the target motion detection mechanism is adjusted according to the image characteristic; and detecting the film mode comprises utilizing the target motion detection mechanism to detect the film mode according to the motion threshold.

10. The method of claim 1, wherein the candidate motion detection mechanisms comprises a field motion detection and a frame motion detection.

11. The method of claim 1, wherein detecting the image characteristic of at least one field comprises detecting a plurality of image characteristics of a plurality of fields respectively; and selecting the target motion detection mechanism out of the plurality of candidate motion detection mechanisms comprises dynamically selecting the target motion detection mechanism according to the image characteristics.

12. The method of claim 1, wherein the target motion detection mechanism has been selected prior to the process of the film mode detection module.

13. A method for detecting an image characteristic of a field, comprising:
calculating a plurality of motion values of a plurality of pixels in the field;
comparing the motion values with at least one threshold value to generate a plurality of comparison results;
analyzing the motion values to determine a motion area; and
determining the image characteristic according to at least one of the comparison results and the motion area.

14. The method of claim 9, wherein comparing the motion values with at least one threshold value comprises:
utilizing at least one threshold value to quantize the motion values to generate the comparison results; and
determining the image characteristic comprises:
summing up the comparison results to determine the image characteristic.

15. An apparatus for detecting a film mode, comprising:
an image characteristic detection module, for detecting an image characteristic based on at least one field of a received video signal, and generating a control signal to select a target motion detection mechanism out of a plurality of candidate motion detection mechanisms according to the image characteristic; and
a film mode detection module, receiving the control signal and detecting the film mode by utilizing the target motion detection mechanism.

16. The apparatus of claim 11, wherein the image characteristic detection module comprises:
a detector, for detecting a noise level of the field; and
an analyzer, coupled to the detector, for determining the image characteristic according to the noise level and generating the control signal to select the target motion detection mechanism out of the plurality of candidate motion detection mechanisms.

17. The apparatus of claim 16, wherein the detector comprises:
a motion calculating unit, for calculating a plurality of motion values of a plurality of pixels in the field;
a comparing unit, coupled to the motion calculating unit, for comparing the motion values with at least one threshold value to generate a plurality of comparison results; and
a determining unit, coupled to the comparing unit, for determining the noise level according to the comparison results

18. The apparatus of claim 17 wherein the comparing unit is a quantizer, utilizing at least one threshold value to quantize the motion values to generate the comparison results.

19. The apparatus of claim 18, wherein the determining unit is an adder, summing up the comparison results to determine the noise level.

20. The apparatus of claim 16, wherein the detector comprises:
a first motion calculating unit, for calculating a plurality of first motion values of a plurality of pixels in the field;
a filter, for performing a filtering operation upon the field to generate a filtered field;
a second motion calculating unit, coupled to the filter, for calculating a plurality of second motion values of the pixels in the filtered field; and
a determining unit, coupled to the first motion calculating unit and the second motion calculating unit, for determining the noise level according to the first motion values and the second motion values.

21. The apparatus of claim 15, wherein the image characteristic detection module comprises:
a detector, for detecting a motion level of the field; and
an analyzer, coupled to the detector, for determining the image characteristic according to the motion level and generating the control signal to select the target motion detection mechanism out of the plurality of candidate motion detection mechanisms.

22. The apparatus of claim 15, wherein the image characteristic detection module comprises:
a detector, for detecting a motion area of the field; and
an analyzer, coupled to the detector, for determining the image characteristic according to the motion area and generating the control signal to select the target motion detection mechanism out of the plurality of candidate motion detection mechanisms.

23. The apparatus of claim 15, wherein the image characteristic detection module adjusts at least a motion threshold referred to by the target motion detection mechanism according to the image characteristic; and the film mode detection module utilizes the target motion detection mechanism to detect the film mode according to the motion threshold.

24. The apparatus of claim 15, wherein the candidate motion detection mechanism comprises a field motion detection and a frame motion detection.

25. The apparatus of claim 15, wherein the image characteristic detection module detects the image characteristic of at least one field by detecting a plurality of image characteristics of a plurality of fields respectively, and selects the target motion detection mechanism out of the plurality of candidate motion detection mechanisms by dynamically selecting the target motion detection mechanism according to the image characteristics.

26. The apparatus of claim 15, wherein the image characteristic detection module selects the target motion detection mechanism prior to the process of the film mode detection module.

27. An apparatus for detecting an image characteristic of a field, comprising:
a motion calculating unit, for calculating a plurality of motion values of a plurality of pixels in the field;
a comparing unit, coupled to the motion calculating unit, for comparing the motion values with at least one threshold value to generate a plurality of comparison results;
an analyzing unit, coupled to the motion calculating unit, for analyzing the motion values to determine a motion area and determining the image characteristic according to the motion area; and
a determining unit, coupled to the comparing unit, for determining the image characteristic according to the comparison results.

28. The apparatus of claim 27, wherein the comparing unit is a quantizer, utilizing at least one threshold value to quantize the motion values to generate the comparison results; and the determining unit is an adder, summing up the comparison results to determine the noise level.
